(19) United States
(12) Patent Application Publication
(10) Pub. No.: US 2005/0177392 A1
(43) Pub. Date: Aug. 11, 2005

(54) Electronic prescription handling system

(76) Inventor: Constantine A. Domashnev, Pittsburgh, PA (US)

Correspondence Address: THE WEBB LAW FIRM, P.C., 700 KOPPERS BUILDING, 436 SEVENTH AVENUE, PITTSBURGH, PA, 15219, US

(21) Appl. No.: 10/773,912

(22) Filed: Feb. 6, 2004

(51) Int. Cl. G06F 17/60

(52) U.S. Cl. 705/2

(57) ABSTRACT

An electronic prescription handling system includes a first computer configured to transmit a prescription, a server configured to receive the prescription, a first pharmacy having a first pharmacy computer, wherein the first pharmacy computer is configured to retrieve the prescription and transmit a first bid for the prescription to the server, wherein the first bid is stored on the server, a second pharmacy having a second pharmacy computer wherein the second pharmacy computer is configured to retrieve the prescription and transmit a second bid for the prescription to the server, wherein the second bid is stored on the server, and a second computer configured to retrieve the first bid and the second bid and to select one of the first bid and the second. When the first bid is selected, the first pharmacy fills the prescription and when the second bid is selected, the second pharmacy fills the prescription.

### BACKGROUND OF THE INVENTION

1. Field of the Invention

The present invention relates to a system and method for generating a prescription from an Internet connected computer and, more specifically, providing a lower cost prescription to a patient by inviting bids for the prescription.

2. Description of Related Art

A majority of visits to a physician's office by a patient results in the physician writing a prescription for the patient and, thereafter, the patient taking the prescription to a local pharmacy to have the prescription filled. There are several shortcomings in this traditional prescription writing approach.

First, as most patients routinely experience, the physician's hand-written prescription is often illegible. An experienced pharmacist may be able to decipher most hand-written prescriptions. However, at least three kinds of errors and inefficiencies are bound to happen at the pharmacy on a regular basis: (a) the pharmacist is unable to read the prescription and must call the physician's office, wasting both the physician's and the pharmacist's time; (b) the pharmacist misreads the prescription and dispenses the wrong drug to the patient with potentially catastrophic results; or (c) the pharmacist can read the physician's prescription, but makes a mistake in manually typing in the prescription to the pharmacy's computer and dispenses the wrong drug to the patient. All of these errors cause inefficiencies and have the potential for disastrous consequences to the patient, the physician, the pharmacist, as well as to the health care industry at large.

Second, there are inefficiencies at the physician's office in generating the prescription. At the time of writing the prescription, the physician generally does not have the full information on what other drugs the patient may be taking. Some drugs that the patient is currently taking or has recently taken may adversely interact with the drug the physician is about to prescribe to the patient. Many patients do not have this information and even if a patient is able to provide some of that information, that information may not be complete or reliable. This inability to check for the possible adverse drug interaction, referred to as DUR or Drug Utilization Review, at the time of writing the prescription wastes time and money in a variety of ways: (a) in the most extreme situation, the patient having been prescribed and having taken incompatible drugs may suffer serious medical consequences, sometimes even death; and (b) even if the drug's incompatibility is discovered by the pharmacist, the pharmacist must call the physician's office because the pharmacist cannot dispense a substitute drug without the physician's authorization.

Third, it would also be useful for the physician to have the patient's other medical history. For example, the patient may have allergies with respect to certain types of drugs. Additionally, the patient's medical history may indicate that certain drugs, even though harmless, do not have the desired or intended effect on the patient. Thus, having the patient's medical history enables the physician to prescribe more appropriate drugs to the patient.

Fourth, at the time of writing the prescription, the physician does not know whether the particular drug being prescribed is covered by the patient's insurance policy. If the drug is not covered (or covered, but not preferred by the insurance provider), the patient will incur unnecessary expense and the insurance provider may also incur additional expenses. Thus, it would be beneficial for the physician to have access to and follow the preferred drug guidelines of the patient's insurance provider (i.e., formulary compliance). Otherwise, the physician will need to reissue the prescription, which results in a loss of billable time or time that may be more productively spent.

Systems for issuing electronic prescriptions are known in the art. For example, U.S. Pat. No. 5,845,255 to Mayaud discloses a wireless device connected to a central database for accessing drug utilization and formulary compliance information. The wireless device is further utilized to electronically write and transmit a prescription to a pharmacy.

However, the prior art requires that the physician have access to a computer that is configured to provide prescription writing and submission capabilities. For example, the computer may be a specialized computer having a proprietary interface with a pharmacy computer. Alternatively, the specialized computer may be operating proprietary software not available on other computers. Finally, patient information necessary in writing the prescription may only be accessed from the specialized computer. Typically, such specialized computers are only found in a medical environment, thus prohibiting the physician from writing and submitting an electronic prescription outside such an environment. This shortcoming may inconvenience the physician and/or patient when a prescription is necessitated and access to the specialized computer is limited or unavailable.

Furthermore, the prior art does not provide the patient with the cost for the prescribed drug. Even if the prior art provides the cost of the drug, the cost is estimated and is not specific to any one pharmacy. Thus, if the cost of the prescribed drug is a key factor in deciding from which pharmacy to purchase the drug, the patient is required to contact each individual pharmacy. Additionally, even if the patient purchases the prescribed drug from the pharmacy selling the drug at the lowest cost in relation to the cost advertised by other pharmacies, the cost of the drug may still be higher than dictated by the current market demand for that drug. Therefore, the patient may still be paying much more for the drug than is necessary.

### SUMMARY OF THE INVENTION

To overcome the deficiencies of the prior art, what is needed, and has not heretofore been developed, is a system and method for providing a physician with authenticated access to generate a prescription from any Internet connected computer, whereby a patient for whom the prescription is written invites bidding on his or her prescription in order to realize cost savings over market-priced drugs.

Accordingly, an electronic prescription handling system is provided that includes a first computer, a server, a first pharmacy, a second pharmacy, and a second computer. The first computer is configured to transmit a prescription. The server is communicatively connected to the first computer, wherein the server is configured to receive the prescription from the first computer. The first pharmacy has a first pharmacy computer communicatively connected to the server, wherein the first pharmacy computer is configured to retrieve the prescription from the server, and the first pharmacy computer is configured to transmit a first bid for the prescription to the server, wherein the first bid is stored on the server. The second pharmacy has a second pharmacy computer communicatively connected to the server, wherein the second pharmacy computer is configured to retrieve the prescription from the server, and the second pharmacy computer is configured to transmit a second bid for the prescription to the server, wherein the second bid is stored on the server. The second computer is communicatively connected to the server, wherein the second computer is configured to retrieve the first bid and the second bid and to select one of the first bid and the second bid. When the first bid is selected, then the first pharmacy fills the prescription, and when the second bid is selected, then the second pharmacy fills the prescription.

The electronic prescription handling system may further include a portable storage medium configured to be interfaced with the first computer, wherein the portable storage medium includes an application for transmitting a digital certificate to the server when the portable storage medium interfaces with the first computer. The server is configured to authenticate the digital certificate and transmit a prescription entry web page to the first computer.

The server stores pharmacy data, such as contact information, for the first pharmacy and the second pharmacy. The server is configured to transmit an address of the first pharmacy or the second pharmacy and a set of directions from the first pharmacy or the second pharmacy to an address specified by the second computer. Furthermore, the server is configured to transmit a map illustrating the address of the first pharmacy or the second pharmacy on the map.

A method for issuing a prescription is also disclosed, wherein the method includes submitting a plurality of bids for the prescription and then selecting from one of the plurality of bids.

These and other advantages of the present invention will be understood from the description of the preferred embodiments, taken with the accompanying drawings, wherein like reference numerals represent like elements throughout.

### BRIEF DESCRIPTION OF THE DRAWINGS

FIG. 1 is a schematic drawing of the entities and communications links involved in an electronic prescription handling system according to the present invention;

FIG. 2 is a front perspective view of a portable storage medium for authenticating a physician;

FIG. 3 is a screen shot of a patient information entry form to be completed by the physician;

FIG. 4 is a screen shot of a drug entry form to be completed by the physician;

FIG. 5 is a series of screen shots showing the issuance of a prescription for a patient based upon patient information, a drug, a corresponding dosage, and accompanying instructions;

FIG. 6 is a screen shot of a bid placement form for submitting bids; and

FIG. 7 is a screen shot of a bid selection form for showing the submitted bids.

### DESCRIPTION OF THE PREFERRED EMBODIMENTS

The present invention will now be described with reference to the accompanying figures. It is to be understood that the specific system illustrated in the attached figures and described in the following specification is simply an exemplary embodiment of the present invention.

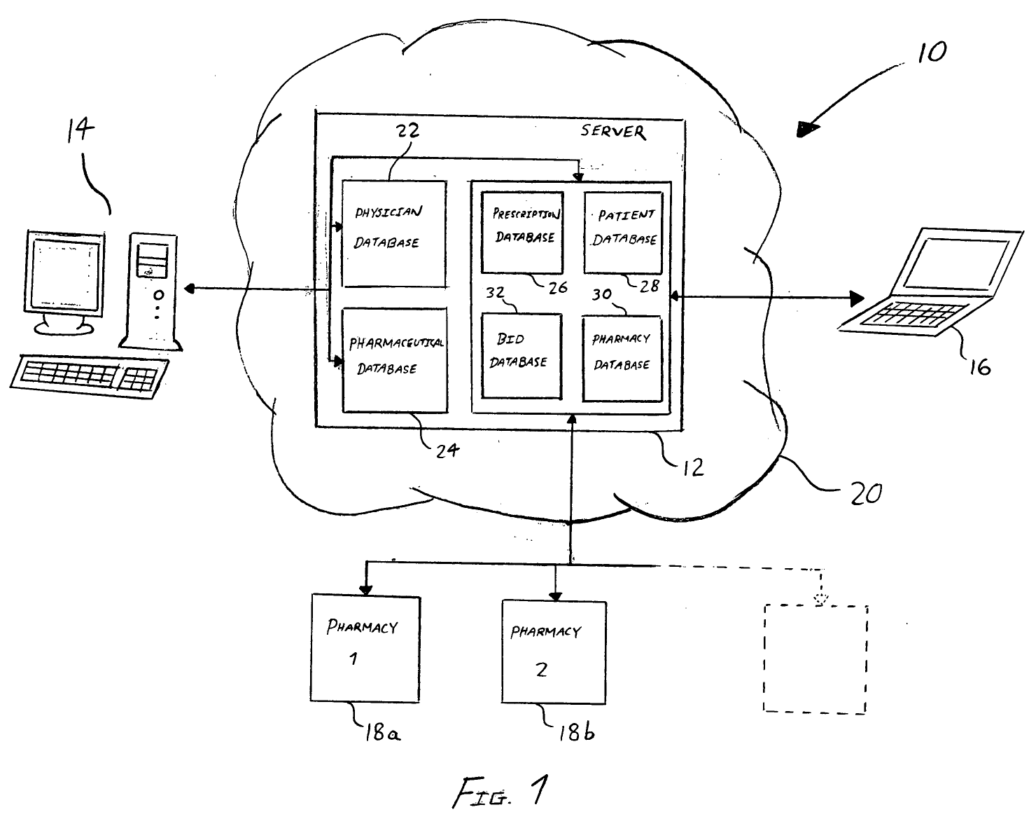

With reference to FIG. 1, the entities and the communicative connectivity between the entities within an electronic prescription handling system 10 will now be described. In a desirable embodiment, the electronic prescription handling system 10 includes a server 12, a first computer 14, a second computer 16, and a plurality of pharmacies, such as a first pharmacy 18a and a second pharmacy 18b. Utilizing a computer network 20, such as the Internet, the central server 12 is communicatively connected to the first computer 14, the second computer 16, and computers of the plurality of pharmacies 18a, 18b.

The server 12 may be any suitable computer system that is configured to transmit and receive data to and from the first computer 14, the second computer 16, and the plurality of pharmacies 18a, 18b. In the context of the Internet or other computer network, the server 12 may function as a web server, thereby transmitting data, e.g., web pages, and receiving data, e.g., user inputted data forms. The server 12 may be operated and maintained by a service provider implementing the electronic prescription handling system 10. The server 12 may be construed to embody more than one physical machine to allow for distributed computing. It is to be understood that communications between the above communicative entities may be implemented in a variety of ways including, but not limited to, land-line, wireless, and satellite-based systems. Thus, the communication links described hereinafter are merely exemplary and are not to be construed as limiting the invention in any manner. The server 12 is communicatively connected to a physician database 22 and a pharmaceutical database 24. The physician database 22 includes a plurality of physician profiles with corresponding identifiers to be used in authenticating a physician who accesses the server 12. Specifically, the server 12 is configured to authenticate digital certificates transmitted to the server 12 by the physician. Those having ordinary skill in the art would appreciate the necessary hardware and programming required to implement a suitable authentication system. The pharmaceutical database 24 includes a plurality of drug formularies. Additionally the pharmaceutical database 24 may have information pertaining to possible adverse drug interactions and side effects associated with any of the drugs in the drug formularies. Furthermore, the server 12 may include a prescription database 26, a patient database 28, a pharmacy database 30, and a bid database 32. The prescription database 26 may store electronic prescriptions submitted and written by the physician. The patient database 28 may store patient profiles, wherein the profiles may include but are not limited to, the name of a patient, contact information, payment form, insurance provider information, drug coverage information, and drug interaction and allergic reaction information. The pharmacy database 30 stores pharmacy data for the plurality of pharmacies 18a, 18b, such as the names, contact information, and addresses of the first pharmacy 18a and the second pharmacy 18b. The bid database 32 is configured to store bids received from the plurality of pharmacies 18a, 18b. A bid may include, but is not limited to, the dispensing pharmacy, the delivery type and/or availability, the quantity, the drug manufacturer, and the price. It is to be understood that the above-described databases do not necessarily need to exist as individual databases, as one or more of the databases may be integrated into another database. Furthermore, the databases may also be physically located external of the server 12.

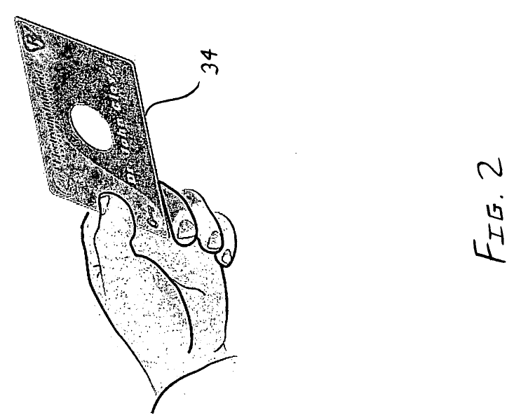

The first computer 14 may include, but is not limited to, a desktop computer, a notebook computer, or a personal digital assistant. The first computer is utilized by an individual, namely, the physician, in prescribing a pharmaceutical to the patient. The first computer 14 is configured to access the server 12 in order for the physician to write and submit the prescription. With reference to FIG. 2 and with continuing reference to FIG. 1, FIG. 2 shows a portable storage medium 34, such as a modified compact disc, that is configured to interface with the first computer 14. For example, the modified compact disc may have the dimensions of a typical business card, so that the physician may easily carry the portable storage medium. The ability to store the compact disc in a wallet avoids the nuisance involved in carrying a regular-sized compact disc. It is to be understood that the modified compact disc is mentioned for exemplary purposes and that the portable storage medium may encompass various formats, including, but not limited to, a DVD and flash memory. The portable storage medium 34 may include an application configured to securely, through appropriate encryption, transmit a digital certificate to the server 12 when the portable storage medium 34 interfaces with the first computer 14. The digital certificate may identify the physician who is utilizing the portable storage medium 34 to write and submit the prescription. For example, upon inserting the modified compact disc into a CD-ROM drive of the first computer 14, the CD-ROM is read by the first computer 14. It is to be understood that the first computer 14 may be configured to automatically execute the application residing on the CD-ROM via automatic execution protocols inherent in the operating system of the first computer 14. An example of such an automatic execution protocol is the “auto-run” feature found in the Windows® operating system. Upon execution of the application, the digital certificate is transmitted to the server 12. The digital certificate stored on the portable storage medium 34 is unique and may be hidden and/or encrypted so that it cannot be copied from the portable storage medium 34. Thus, any physician who is in possession of the portable storage medium 34 is deemed to have signed the prescription resulting from the use of the particular portable storage medium 34.

The first pharmacy 18a and the second pharmacy 18b are communicatively connected to the server 12 via one or more computers (not shown) corresponding to either the first pharmacy 18a or the second pharmacy 18b. It is to be understood that the intended meaning of a pharmacy is to encompass brick-and-mortar pharmacies as well as online pharmacies. Additionally, any mass distributor or seller of pharmaceuticals may also be considered to be a pharmacy. For exemplary purposes, assume that the first pharmacy 18a is a brick-and-mortar pharmacy and the second pharmacy 18b is an online pharmacy. It is to be understood that one or more computers utilized by a brick-and-mortar pharmacy do not necessarily need to be physically present in the first pharmacy 18a. For example, the first pharmacy 18a may be part of a chain of pharmacies. Thus, the computer corresponding to the first pharmacy may physically exist at the corporate headquarters of the chain of pharmacies. Desirably, the computers of the first pharmacy 18a and the second pharmacy 18b are each configured to access the server 12 in order to retrieve or receive bid information, store bid information, process bid information, and transmit bid information.

Similar to the first computer 14, the second computer 16 may include, but is not limited to, a desktop computer, a notebook computer, or a personal digital assistant. The second computer is utilized by another individual, namely, the patient, to access the server 12. Specifically, the second computer 16 is configured to view bid information, including individual bids, by retrieving the bid information from the server 12 and displaying the information, desirably, in a web browser, e.g., Internet Explorer, of the second computer 16. The second computer 16 is also configured to transmit bid selection information to the server 12. Additionally, the patient may utilize the second computer 16 to access the server 12 in order to update his or her profile.

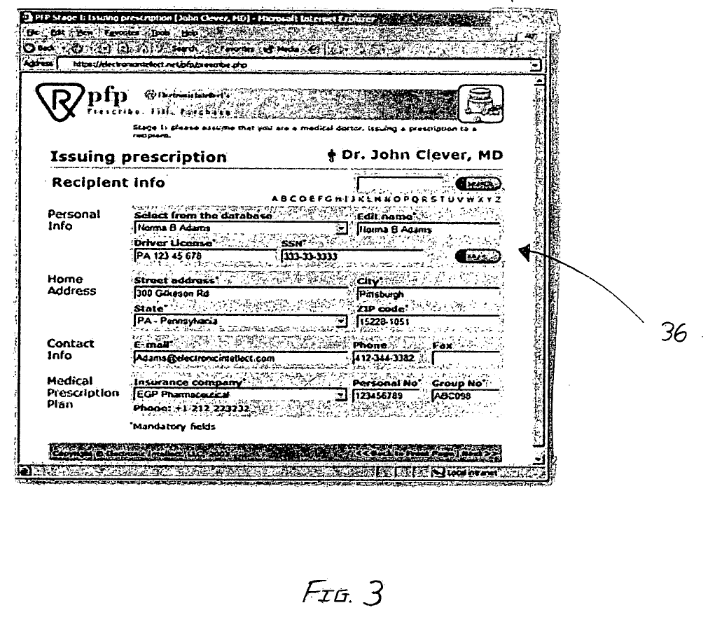

With reference to FIGS. 3-7 and with continuing reference to FIGS. 1 and 2, the operation of the electronic prescription handling system 10 will now be described. Desirably, the physician subscribes with the service provider implementing the electronic prescription handling system 10. Thereafter, the service provider provides the physician with the portable storage medium 34, such as a CD-ROM, to uniquely identify the physician as a subscriber of the electronic prescription handling system 10. This allows the physician to utilize the service provider in writing and submitting prescriptions on behalf of the patient. Specifically, the physician inserts the portable storage medium 34 into the first computer 14. The first computer 14 reads the CD-ROM and automatically executes the application that transmits the digital certificate to the server 12. The digital certificate is then securely transmitted to the server 12 through the computer network 20. Upon receipt of the digital certificate by the server 12, the server 12 may utilize the physician database 22 to authenticate and verify the credentials of the physician. The use of the CD-ROM, or any other type of portable storage medium 34, may eliminate the use of a traditional user name and password login procedure in authenticating the physician. Security and privacy concerns are eliminated by utilizing the portable storage medium 34, as this method is immune from keystroke logging, use of hidden cameras, or other eavesdropping techniques. It is to be understood that the physician may still utilize the user name and password login procedure instead of the portable storage medium 34. Alternatively, the electronic prescription handling system 10 may utilize the traditional user name and password login procedure in conjunction with the portable storage medium 34. Thus, the physician is given the option of utilizing various authentication methods. If the portable storage medium 34 is reported as lost or stolen, the digital certificate on the portable storage medium 34 is suspended and prescriptions having been issued after the loss or theft of the portable storage medium 34 are recalled and removed from the electronic prescription handling system 10. The physician is then provided with a new portable storage medium 34 having a new digital certificate thereon.

After the physician has been authenticated and his or her credentials have been verified, the application, through appropriate commands transmitted by the server 12, initiates an Internet Explorer session on the first computer 14. A prescription entry web page, including a patient information entry form 36 and a drug entry form 38 are then displayed on the first computer 14. Specifically, as shown in FIG. 3, the patient information entry form 36 may include fields for the entry of the patient's personal information including, but not limited to, his or her name, driver's license, social security number, and contact information. Additionally, fields for the entry of an insurance provider, insurance provider number, and group number corresponding to the patient may also be displayed. The physician then completes the form with the appropriate information of the patient for whom the prescription is being written. As previously discussed, the patient database 28 may already include the data required for entry into the patient information entry form 36. Thus, the physician may simply select the patient name and the corresponding patient record with patient information which is automatically transmitted to the first computer 14 by the server 12 and entered into the patient information entry form 36. Thus, the physician no longer needs to manually enter any further patient information. Alternatively, if the physician wishes to write a prescription for a new patient, the corresponding patient data will not be stored in the patient database 28 and, therefore, needs to be manually entered into the patient information entry form 36. This new patient data may then be transmitted to the server 12 to be stored in the patient database 28 as a patient record. Thus, at a subsequent writing of a prescription, the new patient data may be retrieved from the server 12, as is the case with patient data currently stored in the patient database 28.

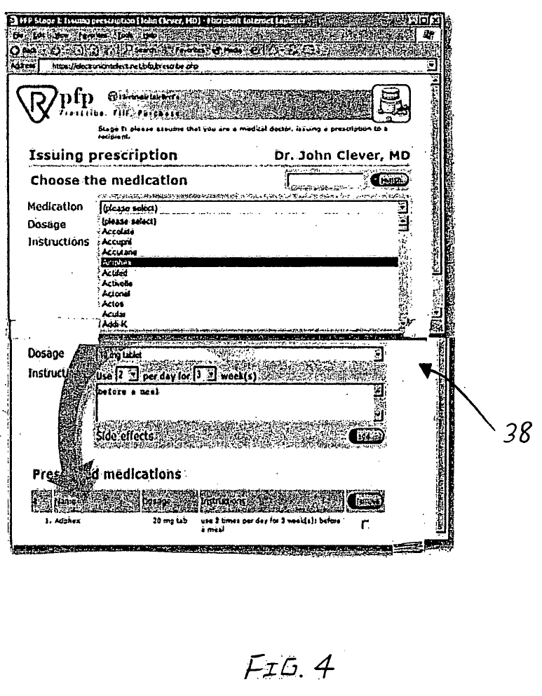

After entering the appropriate information in the patient information entry form 36, the physician is presented with a drug entry form 38, as shown in FIG. 4. The drug entry form 38 may include fields for selecting the type of medication or drug and the corresponding dosage and accompanying instructions. For example, the drug entry form 38 may include a drop down box listing the names of drugs in alphabetical order. Desirably, the drug listing is up-to-date due to the drug listing being provided by the pharmaceutical database 24 of the server 12. Additionally, the drug entry form 38 may also provide the physician with information regarding the patient's medical history including, but not limited to, drugs currently taken by the patient and adverse reactions to certain drugs. The drug listing may also indicate which drugs are covered by the patient's insurance provider. Furthermore, the drug listing may indicate drug equivalents to compensate for drugs not covered by the patient's insurance provider. Based upon the pharmaceutical needs of the patient and any of the above information, the physician selects the appropriate drug in the drug entry form 38. The physician may then select the appropriate dosage and may optionally add any related usage instructions pertaining to that drug. It is to be understood that the physician may select more than one drug in order to create more than one prescription for the patient. It is to be understood that during the process of completing any of the forms required in writing the prescription, the first computer 14 and the server 12 remain communicatively connected in order to exchange information required in completing the requisite forms.

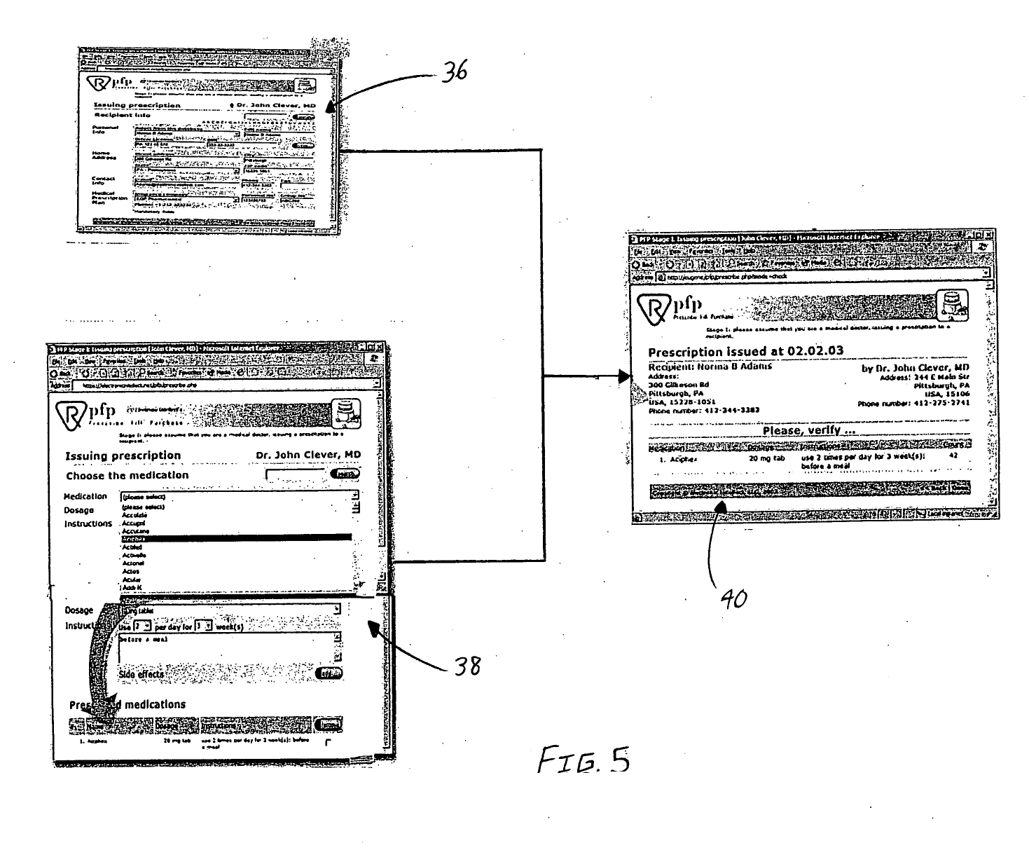

The information provided by the physician in the patient information entry form 36 and the drug entry form 38 is then transmitted to the server 12. As shown in FIG. 5, the server 12 utilizes this information to generate an electronic prescription 40. The electronic prescription 40 may then be stored in the prescription database 26. At a predetermined time, the electronic prescription may be made available by the server 12 to the plurality of pharmacies 18a, 18b. After viewing the electronic prescription 40, the plurality of pharmacies 18a, 18b may each submit a bid to the server 12 representative of the price that each of the plurality of pharmacies 18a, 18b is willing to pay for that particular electronic prescription 40. The bid may also dictate the terms of delivery, e.g., overnight delivery, regular mail, patient pick-up, etc. The server 12 receives the bids and publishes the bids for the plurality of pharmacies 18a, 18b to be able to review. Thereafter, for a specified amount of time, i.e., the duration of the auction, the plurality of pharmacies 18a, 18b may engage in further bidding for the prescription. Any of the plurality of pharmacies 18a, 18b may also access the prescription database 26 at any time to view any outstanding electronic prescriptions 40 for which no bid has yet been placed.

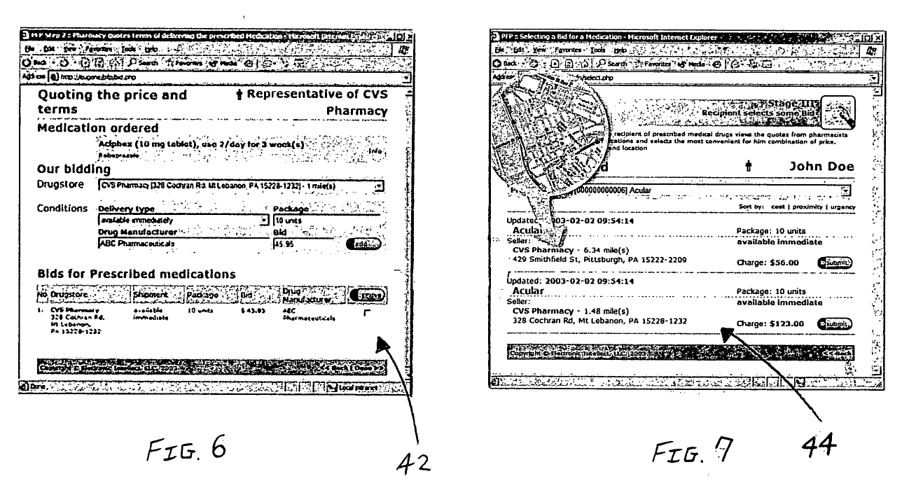

For example, as shown in FIG. 6, the first pharmacy 18a may access the prescription database 26 by logging into the server 12 through a web browser, e.g., Internet Explorer, and viewing a bid placement form 42. The bid placement form 42 includes fields for placing new bids and for viewing bids already placed for the electronic prescription 40. The first pharmacy 18a may place a bid for the electronic prescription 40 by completing the requisite fields. The bid of the first pharmacy 18a is then transmitted to the server 12 and is stored in the bid database 32. The second pharmacy 18b may also log into the server 12 in a similar manner as the first pharmacy 18a and may be presented with the bid placement form 42. The second pharmacy 18b may then view the bid of the first pharmacy 18a and place its own bid, accordingly. The bidding may then continue in a similar fashion until the auction for that particular electronic prescription closes. It is to be understood that as the number of users and prescriptions increases, the electronic prescription handling system 10 may also be configured to accept autonomous bidding by the plurality of pharmacies 18a, 18b, and thereby not require user intervention in the bidding process. It is also envisioned that a single bid by the plurality of pharmacies 18a, 18b may also be directed to a lot containing more than one electronic prescription 40.

After the auction has closed, desirably, the patient is alerted by the server 12 via an email alert sent to the second computer 16 of the patient, that the auction is closed and that the bids are available for viewing and selection. The second computer 16 may access the bids stored in the bid database 32 by logging into the server 12 through a web browser, e.g., Internet Explorer, and viewing a bid selection form 44. The bid selection form 44 displays the bids corresponding to the electronic prescription 40 intended for the patient. The bids of the plurality of pharmacies 18a, 18b may differ in various aspects, such as in the delivery type and/or availability, the quantity, the drug manufacturer, and the price. It is to be understood that after the placement of the bid by the second pharmacy 18b, there may not necessarily be a “winning” bid. Due to the various aspects of a bid, the patient may favor one bid over another bid, even if the price of the selected bid is higher than any other bid. For example, if the bid of the first pharmacy 18a in terms of price is higher than that of the second pharmacy 18b, the patient may still consider the bid of the first pharmacy 18a as the “winning” bid because the prescription may be received by the patient immediately, due to the first pharmacy being a brick-and-mortar pharmacy, as opposed to the patient having to wait for the mailing of the prescription from the online second pharmacy 18b. With each bid shown on the bid selection form 44, the corresponding pharmacy 18a, 18b and address thereof is also displayed. By using each bidding pharmacy's address from the pharmacy database 30 and the patient's address from the patient database 28, the server 12 may indicate the distance of the bidding pharmacies 18a, 18b from the patient's home or other patient specified location. The distance information may be supplanted with driving directions and/or a map illustrating the address of any of the brick-and-mortar pharmacies.

Having the above bid information allows the patient to review the bids and then to select the bid that most closely matches the patient's needs, either medically, financially, geographically, timely, or any combination thereof. After the patient selects a bid, the patient has the option of paying for the electronic prescription 40 through the server 12 or directing payment to the pharmacy that placed the “winning” bid. Payment for filling of the electronic prescription 40 may be facilitated by the patient's payment form stored in the patient database 28. The server 12 then transmits the “winning” bid with the corresponding electronic prescription 40 to the pharmacy that placed the “winning” bid. In addition to the patient information contained within the electronic prescription 40, the server 12 may also transmit other relevant patient information, such as insurance provider information and drug interaction and allergic reaction information, to the pharmacy in order for the pharmacy to safely and efficiently fill the electronic prescription 40. The server 12 may also electronically submit a medical insurance claim listing the electronic prescription 40 to the patient's insurance provider. The patient may then be contacted by either the winning pharmacy or by the server 12 as to the status of the filling of the prescription.

It is to be understood that the present invention may also accommodate bids for refills on the patient's prescription. For example, the server 12 may note any refill information that was originally written by the prescribing physician and automatically open a new auction based upon an estimated date when the original prescription has been exhausted and when the patient requires a refill. Alternatively, the patient may log into the server 12 and indicate that a refill is required, thereby initiating a new auction for a refill of the prescription.

The above invention has been described with reference to the preferred and alternative embodiments. Obvious modifications, combinations, and alterations will occur to others upon reading the proceeding detailed description. It is intended that the invention be construed as including all such modifications, combinations, and alterations insofar as they come within the scope of the appended claims or the equivalents thereof.

1. An electronic prescription handling system comprising:
a first computer configured to transmit a prescription;
a server communicatively connected to the first computer, wherein the server is configured to receive the prescription from the first computer;
a first pharmacy having a first pharmacy computer communicatively connected to the server, wherein:
the first pharmacy computer is configured to retrieve the prescription from the server; and
the first pharmacy computer is configured to transmit a first bid for the prescription to the server, wherein the first bid is stored on the server;
a second pharmacy having a second pharmacy computer communicatively connected to the server, wherein:
the second pharmacy computer is configured to retrieve the prescription from the server; and
the second pharmacy computer is configured to transmit a second bid for the prescription to the server, wherein the second bid is stored on the server; and
a second computer communicatively connected to the server, wherein:
the second computer is configured to retrieve the first bid and the second bid;
the second computer is configured to select one of (i) the first bid, and (ii) the second bid;
when the first bid is selected, the first pharmacy fills the prescription; and
when the second bid is selected, the second pharmacy fills the prescription.

2. The electronic prescription handling system of claim 1, further comprising a portable storage medium configured to be interfaced with the first computer, wherein the portable storage medium includes an application for transmitting a digital certificate to the server when the portable storage medium interfaces with the first computer.

3. The electronic prescription handling system of claim 2, wherein the portable storage medium is one of (i) a CD-ROM, (ii) a DVD-ROM, and (iii) flash memory.

4. The electronic prescription handling system of claim 2, wherein the server is configured to authenticate the digital certificate.

5. The electronic prescription handling system of claim 4, wherein the server is further configured to transmit a prescription entry web page to the first computer upon the server authenticating the digital certificate.

6. The electronic prescription handling system of claim 5, wherein the server comprises:
a pharmaceutical database for storing a plurality of drug formularies therein; and
a physician database utilized to authenticate the digital certificate.

7. The electronic prescription handling system of claim 6, wherein the server further comprises:
a prescription database for storing the prescription received from the first computer;
a patient database for storing patient information;
a pharmacy database for storing pharmacy data; and
a bid database for storing the first bid and the second bid.

8. The electronic prescription handling system of claim 7, wherein the patient information comprises at least one of (i) an insurance provider identifier for a patient, (ii) a medical history for the patient, (iii) a drug interaction list for the patient, and (iv) an allergic reaction list for the patient;

9. The electronic prescription handling system of claim 7, wherein the pharmacy data comprises contact information for one of (i) the first pharmacy and, (ii) the second pharmacy.

10. The electronic prescription handling system of claim 9, wherein the server is further configured to transmit at least one of (i) an address of the first pharmacy or second pharmacy, and (ii) a set of directions from the first pharmacy or second pharmacy to an address specified by the second computer.

11. The electronic prescription handling system of claim 10, wherein the server is further configured to transmit a map illustrating the address on the map of one of (i) the first pharmacy, and (ii) the second pharmacy.

12. The electronic prescription handling system of claim 1, wherein the first pharmacy is one of a brick-and-mortar pharmacy and an online pharmacy.

13. A method for issuing a prescription, the method comprising the steps of:
transmitting a prescription from a first computer;
receiving the prescription on a server;
retrieving the prescription from the server;
submitting a first bid for the prescription to the server from a first pharmacy having a first pharmacy computer;
submitting a second bid for the prescription to the server from a second pharmacy having a second pharmacy computer;
storing the first bid and the second bid on the server;
transmitting the first bid and the second bid to a second computer;
viewing the first bid and the second bid on the second computer;
making a selection consisting of one of (i) the first bid, and (ii) the second bid;
transmitting the selection to the server; and
informing one of (i) the first pharmacy, and (ii) the second pharmacy to fill the prescription.

14. The method of claim 13, further comprising the steps of:
interfacing a portable storage medium with the first computer, wherein the portable storage medium includes an application for transmitting a digital certificate; and
transmitting the digital certificate to the server.

15. The method of claim 14, further comprising the steps of:
authenticating the digital certificate on the server; and
transmitting a prescription entry web page to the first computer.

16. The method of claim 13, further comprising the steps of transmitting to the second computer at least one of:
contact information of one of (i) the first pharmacy, and (ii) the second pharmacy;
a set of directions from one of (i) the first pharmacy, and (ii) the second pharmacy to an address specified by the second computer; and
a map illustrating an address on the map of one of (i) the first pharmacy, and (ii) the second pharmacy.

17. An electronic prescription handling system comprising:
a computer;
a server communicatively connected to the computer;
a portable storage medium configured to interface with the computer;
an application residing on the portable storage medium, wherein the application is configured to execute once the portable storage medium interfaces with the computer, further wherein the application is configured to transmit a digital certificate to the server upon the application sensing a network connection to the server; and
means for authenticating the digital certificate on the server, wherein when the digital certificate is positively authenticated, the server transmits a prescription entry web page to the computer, further wherein a user of the computer enters a prescription into the prescription entry web page, and thereafter the computer transmits the prescription to the server.

18. The electronic prescription handling system of claim 17, wherein the portable storage medium is one of (i) a CD-ROM, (ii) a DVD-ROM, and (iii) flash memory.

19. The electronic prescription handling system of claim 17, wherein the digital certificate identifies a physician.

20. The electronic prescription handling system of claim 18, wherein the digital certificate is hidden on the portable storage medium.

21. The electronic prescription handling system of claim 20, wherein the digital certificate cannot be copied from the portable storage medium.

22. The electronic prescription handling system of claim 19, wherein the server transmits the prescription to a pharmacy.
